(19) United States
(12) Patent Application Publication
(10) Pub. No.: US 2012/0268090 A1
(43) Pub. Date: Oct. 25, 2012

(54) SWITCHING POWER SUPPLY DEVICE

(76) Inventor: Masato SASAKI, Osaka (JP)

(21) Appl. No.: 13/449,065

(22) Filed: Apr. 17, 2012

(30) Foreign Application Priority Data
Apr. 19, 2011 (JP) 2011-093404

(51) Int. Cl. G05F 1/00

(52) U.S. Cl. 323/271

(57) ABSTRACT

A switching power supply device of the present invention switches an application of a voltage to a coil. The switching power supply device includes: a switching element that (i) has a normally-on type first switching element and a normally-off type second switching element which are cascode-connected to each other at and (ii) switches the application of the voltage to the coil; and a control circuit that (i) detects a voltage at a cascode connecting point and (ii) controls turning-on of the switching element in accordance with the detected voltage.

This Nonprovisional application claims priority under 35 U.S.C. §119 on Patent Application No. 2011-093404 filed in Japan on Apr. 19, 2011, the entire contents of which are hereby incorporated by reference.

### TECHNICAL FIELD

The present invention relates to a switching power supply device which causes a switching operation to produce and output a predetermined voltage.

### BACKGROUND ART

In recent years, switching voltage power supply devices are in widespread use for a variety of devices such as information devices and electrical household appliances. In particular, information devices such as portable terminal devices require various types of power supplies for, for example, driving CPUs, driving display devices, and a communication interface, the power supplies differing in voltage depending on their respective functions. The information devices need to generate these power supplies (i.e. output voltages) from battery-operated power supplies (i.e. input voltages). Therefore, it is common to use a switching power supply device which allows obtainment of a desired output voltage by switching between on/off of an application of a voltage to a coil.

The switching power supply device is exemplified by a technique disclosed in Patent Literature 1 for causing a critical mode PFC (Power Factor Correction) boost converter to (i) detect an input voltage and an output voltage, (ii) carry out a predetermined calculation based on these detected voltages so as to determine an on-time duration and an off-time duration of a switching element, and (iii) turn on/off the switching element in accordance with the on-time duration and the off-time duration thus determined.

It is a common challenge for such a switching power supply device to carry out switching at a suitable timing so as to supply a voltage with stability and efficiency.

### CITATION LIST

### Patent Literature 1

Japanese Patent Application Publication, Tokukai, No. 2010-104218 A (Publication Date: May 6, 2010)

### SUMMARY OF INVENTION

### Technical Problem

On the contrary, a conventional switching power supply device determines, by a predetermined calculation, a timing at which a switching element turns on. Therefore, occurrence of an error in the predetermined calculation causes a shift in timing at which the switching element turns on. Further, a suitable timing at which the switching element turns on changes by changing factors such as an inter-terminal capacitance of the switching element, an inductance value of a coil, and an input voltage. However, the conventional switching power supply device determines, by the predetermined calculation, the timing at which the switching element turns on. Therefore, the conventional switching power supply device is incapable of changing the timing in accordance with the changing factors. This prevents the conventional switching power supply device from causing the switching power supply device to turn on at a suitable timing.

Therefore, the present invention has been made in view of the problem, and an object of the present invention is to provide a switching power supply device capable of further optimizing a timing at which a switching element for switching an application of a voltage to a coil turns on.

### Solution to Problem

In order to attain the object, a switching power supply device in accordance with the present invention which causes a switching element connected to one end of a coil to switch an application of a direct-current voltage to the coil, so as to obtain an output voltage by extracting, at an output thereof, magnetic energy as electric energy which is transferred by an electric current that flows through the coil during an off period of the switching, the magnetic energy having been accumulated in the coil in an on period of the switching, the switching power supply device includes: a normally-on type first switching element and a normally-off type second switching element which are provided in the switching element and are cascode-connected to each other; voltage detecting means for detecting a voltage at a cascode connecting point of the normally-on type first switching element and the normally-off type second switching element; and control means for controlling turning-on of the switching element in accordance with the voltage detected by the voltage detecting means.

According to the configuration, turning-on of the switching element is controlled in accordance with the voltage at the cascode connecting point in the switching element, the voltage determining a suitable timing at which the switching element turns on. Therefore, even in a case where an inter-terminal capacitance of the switching element, an inductance value, or an input voltage causes a change in time lag between (i) when a coil current becomes 0 (zero) and (ii) when a drain voltage of the switching element drops to a given voltage, the configuration prevents the switching element from turning on before the drain voltage of the switching element drops to the given voltage. This enables optimization of the timing at which the switching element turns on. In addition, detection of an electric potential of the cascode connecting point of the normally-on type first switching element and the normally-off type second switching element enables a voltage lower than an inter-terminal voltage of the switching element to control the timing at which the switching element turns on.

It is common that a higher breakdown voltage in a detecting section causes an increase in cost of the detecting section. Further, a wider breakdown voltage range in the detecting section causes a deterioration in detection accuracy of the detecting section. Therefore, the present invention, which is configured to detect the voltage at the cascode connecting point, allows detection of a lower voltage. This enables a reduction in cost of the detecting section and a higher detection accuracy of the detecting section.

It should be noted here that in order to merely reduce the voltage at the detecting section, it may be only necessary to cause a resistor to divide the voltage. However, such an arrangement increases in number of components and causes a conduction loss due to the resistor. The present invention, which does not have such an arrangement, neither increases in number of components nor causes the conduction loss.

### Advantageous Effects of Invention

A switching power supply device in accordance with the present invention can further optimize a timing at which a switching element for switching an application of a voltage to a coil turns on.

### BRIEF DESCRIPTION OF DRAWINGS

FIG. 1 shows a configuration of a switching power supply device in accordance with the present embodiment.

FIG. 2 specifically shows a configuration of control means included in the switching power supply device in accordance with the present embodiment.

FIG. 3 shows waveforms of various parameters which waveforms are obtained during an operation of the switching power supply device in accordance with the present embodiment.

### DESCRIPTION OF EMBODIMENTS

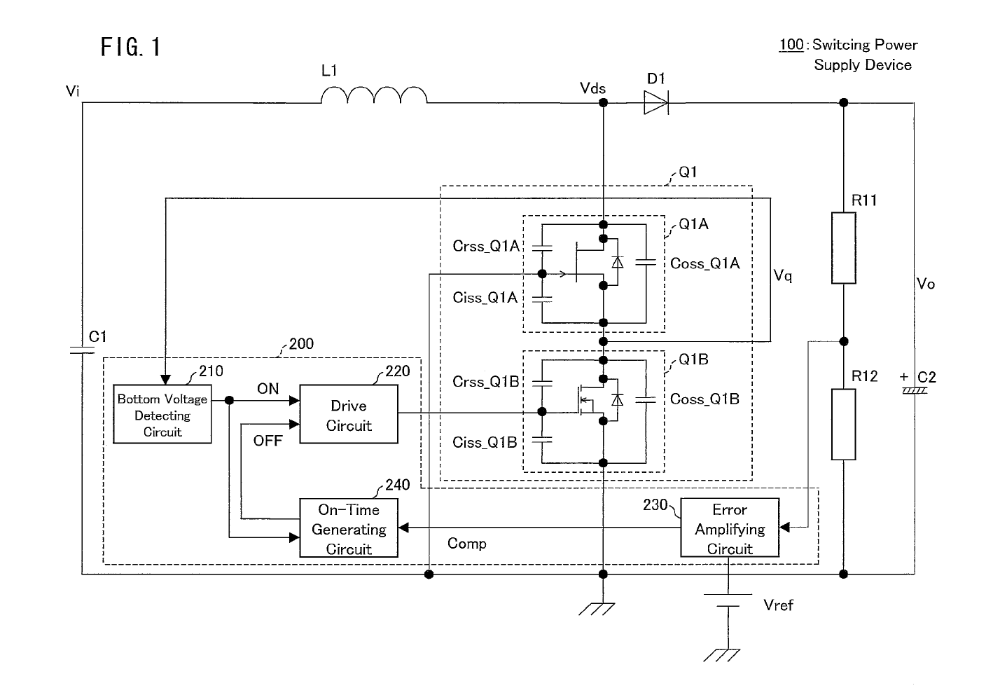

An embodiment in accordance with the present invention is described below with reference to the drawings. FIG. 1 shows a configuration of a switching power supply device 100 in accordance with the present embodiment. The switching power supply device 100 is a so-called boost type switching power supply device. The switching power supply device 100 causes a switching element Q1 provided at one end of a coil L1 to switch an application of a direct-current voltage to the coil L1, and extracts magnetic energy as electric energy at an output thereof, so as to obtain an output voltage Vo by boosting an input voltage Vi. The magnetic energy is stored in the coil L1 in an on period of the switching. The electric energy is transferred by an electric current which flows through the coil L1 in an off period of the switching.

[Configuration of Switching Power Supply Device]

The switching power supply device 100 includes a capacitor C1, a capacitor C2, the coil L1, a diode D1, the switching element Q1, a resistor R11, a resistor R12, and a control circuit 200.

The capacitor C1 is a so-called smoothing capacitor that smoothes the input voltage V1. The coil L1 is a so-called inductor that generates an inductor current in response to an application of the input voltage V1 thereto. The capacitor C2 is a so-called output capacitor. The capacitor C2 is charged by the inductor current generated in the coil L1. This allows obtainment of the output voltage Vo from the capacitor C2. The diode D1 is provided between the coil L1 and the capacitor C2 so as to prevent backflow of the inductor current. The resistors R11 and R12 divide the output voltage Vo.

(Switching Element Q1)

The switching element Q1 switches the application of the input voltage Vi to the coil L1. The switching element Q1 includes a switching element Q1A and a switching element Q1B. The switching element Q1A (first switching element) is a normally-on type field-effect transistor (depletion transistor). An n-channel depletion junction field-effect transistor is used here as the normally-on type field-effect transistor. Alternatively, an n-channel depletion MOS field-effect transistor may also be used. The switching element Q1B (second switching element) is a normally-off type field-effect transistor (enhancement transistor). An n-channel enhancement MOS field-effect transistor is used here as the normally-off type field-effect transistor. The switching element Q1A and the switching element Q1B are cascode-connected to each other.

Specifically, a drain of the switching element Q1B is connected to a source of the switching element Q1A. A source of the switching element Q1B is connected to a gate of the switching element Q1A. Namely, according to the switching element Q1, the drain-source of the switching element Q1B and the source-gate of the switching element Q1A are connected in parallel to each other.

According to the configuration, the switching element Q1 functions as a normally-off type switching element. Namely, an application of a control voltage to the switching element Q1 via its gate causes the switching element Q1 to turn on. This causes the input voltage Vi to be applied to the coil L1. In contrast, stop of the application of the control voltage to the switching element Q1 via its gate causes the switching element Q1 to turn off. This stops the application of the input voltage Vi to the coil L1.

A turn-off operation of the switching element Q1 is specifically described below. First, a reduction in gate voltage of the switching element Q1B causes the switching element Q1B to turn off. This increases a voltage across the source and the drain of the switching element Q1B. This accordingly increases an inverse voltage across the source and the gate of the switching element Q1A. When the inverse voltage reaches a gate threshold voltage of the switching element Q1A, the switching element Q1A turns off, and the switching element Q1 entirely turns off.

Note that, as is clear from the turn-off operation, a maximum tolerated drain-source voltage necessary for the switching element Q1B corresponds to an absolute value of the threshold voltage of the switching element Q1A. This makes it possible to apply, to the switching element Q1B, a switching element whose conduction loss is small and which has a low breakdown voltage. As a result, the switching element Q1 whose conduction loss is small can be made.

A voltage detection wire extending from the control circuit 200 (described later) is connected to a connection (hereinafter referred to as a cascode connecting point) of (i) the drain of the switching element Q1B and (ii) the source of the switching element Q1A. This allows the control circuit 200 to measure an inter-terminal voltage Vq across the drain and the source of the switching element Q1B.

It should be noted that in FIG. 1, (i) Crss_Q1A denotes a feedback capacitance of the switching element Q1A, (ii) Ciss_Q1A denotes an input capacitance of the switching element Q1A, and (iii) Coss_Q1A denotes an output capacitance of the switching element Q1A. A diode provided between the source and the drain of the switching element Q1A refers to a body diode (parasitic diode) of the switching element Q1A.

Similarly, (i) Crss_Q1B denotes a feedback capacitance of the switching element Q1B, (ii) Ciss_Q1B denotes an input capacitance of the switching element Q1B, and (iii) Coss_Q1B denotes an output capacitance of the switching element Q1B. A diode provided between the source and the drain of the switching element Q1B refers to a body diode (parasitic diode) of the switching element Q1B.

(Control Circuit 200)

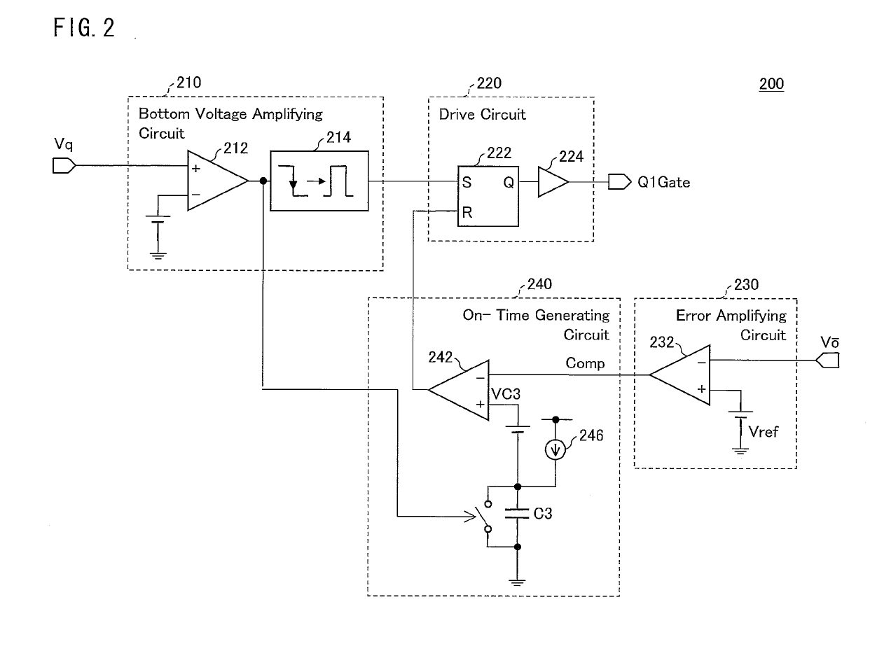

The control circuit 200 controls the switching (i.e. turning-on and turning-off) of the switching element Q1. The control circuit 200 includes a bottom voltage detecting circuit 210, a drive circuit 220, an error amplifying circuit 230, and an on-time generating circuit 240. A configuration of the control circuit 200 is specifically described below. FIG. 2 shows the configuration of the control circuit 200 included in the switching power supply device 100 in accordance with the present embodiment.

(Bottom Voltage Detecting Circuit 210)

The bottom voltage detecting circuit 210 controls an output of a control signal (hereinafter referred to as an on signal) for turning on the switching element Q1. The bottom voltage detecting circuit 210 includes a comparator 212 and a one-shot multivibrator 214.

The comparator 212 has a positive input terminal which is connected to the cascode connecting point. Namely, the comparator 212 receives, via its positive input terminal, the inter-terminal voltage Vq of the switching element Q1B, the inter-terminal voltage Vq having been detected at the cascode connecting point. Accordingly, it can be said that such a configuration is “voltage detecting means for detecting a voltage at the cascode connecting point in the switching element.”

Meanwhile, the comparator 212 receives a threshold voltage via a negative input terminal thereof. A lower limit value of the inter-terminal voltage of the switching element Q1B is preliminarily set for the threshold value. For example, in a case where the inter-terminal voltage of the switching element Q1B is reduced to 0 V, the threshold voltage becomes approximately 0 V.

According to the configuration, the comparator 212 changes a level of the control signal to be supplied therefrom from a high level to a low level at a timing at which the inter-terminal voltage Vq falls below the threshold voltage.

When the level of the control signal received from the comparator 212 is changed to the low level, the one-shot multivibrator 214 supplies the on signal to the drive circuit 220.

Namely, the bottom voltage detecting circuit 210 supplies the on signal to the drive circuit 220 at the timing at which the inter-terminal voltage Vq falls below the threshold voltage.

(Error Amplifying Circuit 230)

The error amplifying circuit 230 includes an op-amp (abbreviation of an operational amplifier) 232. The op-amp 232 amplifies an error between the output voltage Vo and a reference voltage Vref, so as to output the amplified error. Specifically, the op-amp 232 has a negative input terminal which is connected to a connection of the resistor R11 and the resistor R12 and via which the op-amp 232 receives the output voltage Vo divided by the resistor R11 and the resistor R12. Meanwhile, the op-amp 232 receives the reference voltage Vref via a positive terminal thereof. The op-amp 232 finds the error between the output voltage Vo and the reference voltage Vred which have been received, and amplifies the error, so as to output the amplified error as an error signal Comp.

(On-Time Generating Circuit 240)

The on-time generating circuit 240 controls an output of a control signal (hereinafter referred to as an off signal) for turning off the switching element Q1. The on-time generating circuit 240 includes a comparator 242, a capacitor C3, and a constant-current power supply 246.

The comparator 242 receives an output voltage Vcomp of the error amplifying circuit 230 via a negative input terminal thereof, whereas the comparator 242 receives a voltage VC3 of the capacitor C3 via a positive input terminal thereof. The comparator 242 compares the output voltage Vcomp of the error amplifying circuit 230 and the voltage VC3 of the capacitor C3. The comparator 242 outputs the off signal when the voltage VC3 of the capacitor C3 reaches the output voltage Vcomp of the error amplifying circuit 230.

In an on period of the switching element Q1, the capacitor C3 is subjected to a constant current charge carried out by the constant-current power supply 246. This causes a voltage of the capacitor C3 to continue to rise. When the voltage VC3 of the capacitor C3 reaches the output voltage Vcomp of the error amplifying circuit 230, the capacitor C3 outputs the off signal. When the switching element Q1 turns off, the capacitor C3 is discharged.

Since the output voltage Vcomp of the error amplifying circuit 230 is constant during the process described above, the on period of the switching element Q1 is determined by a charging period of the capacitor C3. Accordingly, in order to cause the on period of the switching element Q1 to be in accordance with a desired output voltage, the capacitor C3 is subjected to a constant current charge by use of a desired constant current so that charging of the capacitor C3 for a given period of time causes the voltage VC3 of the capacitor C3 to reach the output voltage Vcomp of the error amplifying circuit 230.

(Drive Circuit 220)

The drive circuit 220 controls the switching of the switching element Q1. The drive circuit 220 includes an FF (flip-flop) 222 and an amplifier 224.

The FF 222 switches between an output of the on signal and an output of the off signal.

Specifically, the FF 222 receives the on signal from the bottom voltage detecting circuit 210 via an S input terminal thereof. Upon receiving the on signal, the FF 222 outputs the on signal via a Q output terminal thereof.

Meanwhile, the FF 222 receives the off signal from the on-time generating circuit 240 via an R input terminal thereof. Upon receiving the off signal, the FF 222 outputs the off signal via the Q output terminal thereof.

The on signal and the off signal each outputted from the flip-flop 222 are amplified by the amplifier 224 and then are supplied to the gate of the switching element Q1.

(Operation of Switching Power Supply Device 100)

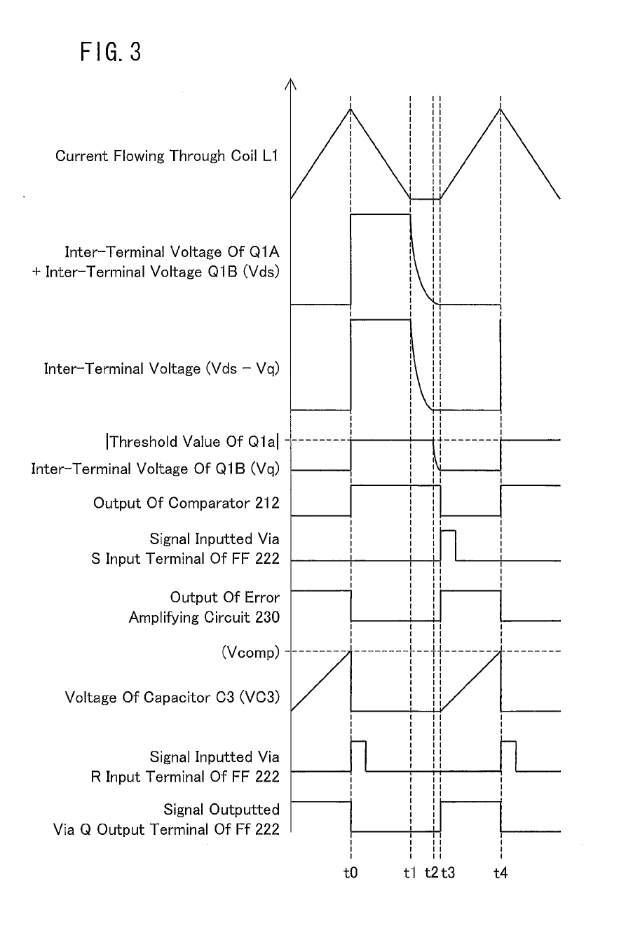

Subsequently, the following description discusses an operation of the switching power supply device 100 in accordance with the present embodiment. FIG. 3 shows waveforms of various parameters which waveforms are obtained during the operation of the switching power supply device 100 in accordance with the present embodiment.

First, when the switching element Q1 turns off (at a timing t0), the inductor current flowing through the coil L1 starts decreasing with a slope of ((output voltage Vo−input voltage Vi)/inductance of coil L1). Concurrently, the capacitor C3 is discharged. In this case, as described earlier, the switching element Q1B has the inter-terminal voltage Vq of the absolute value of the threshold voltage of the switching element Q1A.

When the inductor current flowing through the coil L1 reaches 0 (zero) (at a timing t1), a series resonance occurs between (i) the feedback capacitance Crss_Q1A of the switching element Q1A, (ii) the coil L1, and (iii) the input voltage Vi.

In this case, the inter-terminal voltage of the switching element Q1B, i.e., the voltage Vq at the cascode connecting point in the switching element Q1 remains at the absolute value of the threshold voltage of the switching element Q1A. Accordingly, the input capacitance Ciss_Q1A of the switching element Q1A is not involved in the series resonance.

The series resonance reduces the inter-terminal voltage of the switching element Q1A. This causes a current as much as a change in electric charge of the output capacitance Coss_Q1A to flow from the drain to the source of the switching element Q1A. Accordingly, the output capacitance Coss_Q1A of the switching element Q1A is not involved in the series resonance.

It should be noted that in this case, a parasitic capacitance of the switching element Q1B is not involved in the series resonance, either.

When the inter-terminal voltage of the switching element Q1A reaches 0 V (at a timing t2), the body diode of the switching element Q1A turns on. This causes a series resonance between (i) the feedback capacitance Crss_Q1A of the switching element Q1A, (ii) the input capacitance Ciss_Q1A, (iii) the feedback capacitance Crss_Q1B of the switching element Q1B, (iv), the output capacitance Coss_Q1B, (v) the coil L1, and (vi) the input voltage Vi. In this case, the inter-terminal voltage of the switching element Q1B, i.e., the voltage Vq at the cascode connecting point in the switching element Q1 is equal to a voltage Vds.

It should be noted that, since the inter-terminal voltage of the input capacitance Ciss_Q1B is 0 V, the input capacitance Ciss_Q1B of the switching element Q1B is not involved in the series resonance.

The control circuit 200 compares (i) the inter-terminal voltage Vq detected at the cascode connecting point and (ii) the threshold voltage. The control circuit 200 outputs the on signal when the inter-terminal voltage Vq of the switching element Q1B falls below the threshold voltage (at a timing t3). This causes the switching element Q1 to turn on.

When the switching element Q1 turns on, the input voltage Vi is applied to the coil L1, so that the inductor current flowing through the coil L1 rises. The inductor current flows through the diode D1, so as to charge the output capacitor C2. Namely, this allows obtainment of the output voltage Vo.

Concurrently, the constant-current power supply 246 starts carrying out the constant current charge with respect to the capacitor C3. This causes the voltage VC3 of the capacitor C3 to rise. When the voltage VC3 of the capacitor C3 reaches a value of the error signal Comp outputted from the op-amp 232 (at a timing t4), the on-time generating circuit 240 outputs the off signal. This causes the switching element Q1 to turn off.

The switching power supply device 100 outputs the output voltage Vo continuously and stably by repeating the operation described above.

(Effect of the Switching Power Supply Device 100)

As described earlier, the switching power supply device 100 in accordance with the present embodiment is configured to detect the voltage Vq at the cascode connecting point in the switching element Q1 and then cause the switching element Q1 to turn on in accordance with the voltage Vq thus detected.

According to this, even in a case where any of the inter-terminal capacitance of the switching element Q1, the inductance value of the coil L1, and the input voltage Vi changes, the switching power supply device 100, which is insusceptible to such a change, is capable of causing the switching element Q1 to turn on at a suitable timing in accordance with the drain voltage of the switching element Q1.

Further, since the switching power supply device 100 detects the voltage Vq at the cascode connecting point at which the switching elements Q1A and Q1B are connected to each other, the timing at which the switching element Q1 turns on can be controlled by use of a voltage lower than the inter-terminal voltage of the switching element Q1.

In particular, the switching power supply device 100 is configured to cause the switching element Q1 to turn on when the detected voltage falls below the predetermined threshold voltage.

According to this, the switching element Q1 can turn on at a suitable timing by a simple and secure configuration such that the comparator 212 compares the detected voltage and the threshold voltage and controls turning-on of the switching element Q1 in accordance with a result of the comparison.

Further, the switching power supply device 100 in accordance with the present embodiment uses a normally-on type switching element as the switching element Q1A, and uses a normally-off type switching element as the switching element Q1B.

According to this, the normally-off type switching element Q1 can be made by using, as the switching element Q1A, a normally-off type switching element whose conduction loss is small.

(Supplementary Explanation)

The above description discusses the embodiment in accordance with the present invention. However, the present invention is not limited to the description of the embodiments above, but may be altered by a skilled person within the scope of the claims. An embodiment based on a proper combination of technical means disclosed in different embodiments is encompassed in the technical scope of the present invention.

For example, a circuit configuration of the switching power supply device which configuration is described in the embodiment is merely an example. Even in a case where the present invention is worked by applying, to the switching power supply device, a circuit configuration which is different from the circuit configuration described in the embodiment, the switching power supply device having such a different circuit configuration is also encompassed in the technical scope of the present invention.

Furthermore, according to the embodiment, the control means causes the switching element to turn on when the voltage detected at the cascode connecting point falls below the predetermined threshold voltage. However, an arrangement of the control means is not limited to this. Namely, the control means may have any arrangement, provided that the control means causes the switching element to turn on in accordance with the voltage detected at least at the cascode connecting point.

(Summary)

As described earlier, a switching power supply device in accordance with the present invention which causes a switching element connected to one end of a coil to switch an application of a direct-current voltage to the coil, so as to obtain an output voltage by extracting, at an output thereof, magnetic energy as electric energy which is transferred by an electric current that flows through the coil during an off period of the switching, the magnetic energy having been accumulated in the coil in an on period of the switching, the switching power supply device includes: a normally-on type first switching element and a normally-off type second switching element which are provided in the switching element and are cascode-connected to each other; voltage detecting means for detecting a voltage at a cascode connecting point of the normally-on type first switching element and the normally-off type second switching element; and control means for controlling turning-on of the switching element in accordance with the voltage detected by the voltage detecting means.

According to the configuration, turning-on of the switching element is controlled in accordance with the voltage at the cascode connecting point in the switching element, the voltage determining a suitable timing at which the switching element turns on. Therefore, even in a case where an inter-terminal capacitance of the switching element, an inductance value, or an input voltage causes a change in time lag between (i) when a coil current becomes 0 (zero) and (ii) when a drain voltage of the switching element drops to a given voltage, the configuration prevents the switching element from turning on before the drain voltage of the switching element drops to the given voltage. This enables optimization of the timing at which the switching element turns on. In addition, detection of an electric potential of the cascode connecting point of the normally-on type first switching element and the normally-off type second switching element enables a voltage lower than an inter-terminal voltage of the switching element to control the timing at which the switching element turns on.

It is common that a higher breakdown voltage in a detecting section causes an increase in cost of the detecting section. Further, a wider breakdown voltage range in the detecting section causes a deterioration in detection accuracy of the detecting section. Therefore, the present invention, which is configured to detect the voltage at the cascode connecting point, allows detection of a lower voltage. This enables a reduction in cost of the detecting section and a higher detection accuracy of the detecting section.

It should be noted here that in order to merely reduce the voltage at the detecting section, it may be only necessary to cause a resistor to divide the voltage. However, such an arrangement increases in number of components and causes a conduction loss due to the resistor. The present invention, which does not have such an arrangement, neither increases in number of components nor causes the conduction loss.

It is preferable to arrange the switching power supply device such that the control means causes the switching element to turn on when the voltage detected by the voltage detecting means falls below a predetermined threshold voltage.

According to the configuration, the switching element can turn on at a suitable timing by a simple and secure configuration such that a comparator compares the detected voltage and the threshold voltage and controls turning-on of the switching element Q1 in accordance with a result of the comparison.

### INDUSTRIAL APPLICABILITY

A switching power supply device in accordance with the present invention is applicable to various switching power supply devices which allow obtainment of a desired output voltage by switching between on/off of an application of a voltage to a coil. In particular, the switching power supply device is applicable to a critical mode PFC (Power Factor Correction) boost converter.

### REFERENCE SIGNS LIST

100 Switching power supply device
200 Control circuit (control means)
210 Bottom voltage detecting circuit
220 Drive circuit
230 Error amplifying circuit
240 On-time generating circuit
C1 Capacitor
C2 Capacitor
C3 Capacitor
D1 Diode
L1 Coil
Q1 Switching element
Q1A Switching element (first switching element)
Q1B Switching element (second switching element)
R11 Resistor
R12 Resistor

1. A switching power supply device which causes a switching element connected to one end of a coil to switch an application of a direct-current voltage to the coil, so as to obtain an output voltage by extracting, at an output thereof, magnetic energy as electric energy which is transferred by an electric current that flows through the coil during an off period of the switching, the magnetic energy having been accumulated in the coil in an on period of the switching,
said switching power supply device comprising:
a normally-on type first switching element and a normally-off type second switching element which are provided in the switching element and are cascode-connected to each other;
voltage detecting means for detecting a voltage at a cascode connecting point of the normally-on type first switching element and the normally-off type second switching element; and
control means for controlling turning-on of the switching element in accordance with the voltage detected by the voltage detecting means.

2. The switching power supply device as set forth in claim 1, wherein the control means causes the switching element to turn on when the voltage detected by the voltage detecting means falls below a predetermined threshold voltage.
